(19) United States
(12) Patent Application Publication
(10) Pub. No.: US 2019/0100050 A1
(43) Pub. Date: Apr. 4, 2019

(54) GREETING CARD SYSTEM

(71) Applicant: Nanae Hagihara, Oceanside, CA (US)

(72) Inventor: Nanae Hagihara, Oceanside, CA (US)

(21) Appl. No.: 15/541,700

(22) PCT Filed: Jun. 19, 2017
(86) PCT No.: PCT/US17/38190

§ 371 Date: Jul. 5, 2017

(30) Foreign Application Priority Data
Jun. 20, 2016 (JP) 2016-122032

(51) Int. Cl. B42D 15/04; G09F 1/06; B42D 15/02; G09F 13/10

(52) U.S. Cl. CPC B42D 15/042; G09F 1/06; G09F 2013/0463; G09F 13/10; B42D 15/022

(57) ABSTRACT

A greeting card that can display images three-dimensionally can be stored in an envelope and be easily sent by mail, wherein the receiving person receives the greeting card and may enjoy three-dimensional image card easily.

### CROSS-REFERENCE TO RELATED APPLICATION(S)

The present application claims priority to Japanese Patent Application No. 2016-122032 filed on Jun. 20, 2016, entitled “Greeting Card System” and PCT Application No. PCT/US17/38190 filed on Jun. 19, 2017, entitled “GREETING CARD SYSTEM” the entire disclosures of which are incorporated by reference herein.

### BACKGROUND OF THE INVENTION

### 1. Field of Invention

The present invention relates to the field of greeting card systems using a greeting card that can be stored in an envelope.

### 2. Description of Related Art

Conventionally, an image display device is known as means for displaying a stereoscopic image using a mobile terminal. For example, image display apparatuses disclosed in the prior art include a three-dimensional object, wherein the side walls extend forward from the solid sides of the three-dimensional object, with an inclined transparent plate inclined such that its lower end portion is positioned forward of the upper end portion, and both side walls are formed by arranging a mobile terminal having a downwardly-facing display portion. Then, the image displayed on the display section is three-dimensionally displayed on the transparent plate.

Further, in the example of the three-dimensional image display device of the prior art, a back plate and side plates are foldably connected to both sides of the back plate, a top plate foldably connected to the upper end of the back plate, and a top plate. A transparent plate is surrounded by the back plate, having side faces on both sides and a top plate, and having a space in the interior thereof, wherein the transparent plate is disposed so as to face the back plate in the space. An opening for capturing an image is formed in the upper portion of the main body box structure and a viewing port for viewing the video is formed in the front of the main body box structure. Then, an image appears three-dimensionally on this light transmitting plate.

Based on the foregoing, there is a need in the art for a relatively simple three-dimensional image-projecting apparatus that is suitable for folding as a greeting card and storing and sending in an envelope, as a traditional greeting card.

### SUMMARY OF THE INVENTION

The present invention has been made in view of such circumstances, and it is an object of the present invention to provide a greeting card capable of three-dimensionally displaying a video image, foldable and enclosable in an envelope and easily sent by mail or the like.

A greeting card system according to a first aspect of the present invention is a greeting card system capable of folding a base plate in a substantially flat plate shape that can be stored in an envelope, at least a part of the upper side is opened in a state where the base plate is opened, and an image is displayed on the base plate. A display support for supporting the display is provided, and a transparent or translucent card which is a stereoscopic display having a slanted surface inclined with respect to the display support and a surface of the inclined surface which is provided. The display surface of the display faces the base plate. A storage means is also provided for storing an image to be displayed on the display means, wherein the display means is placed on the display means mounting portion which stands on the base plate in a state where the base plate is opened, and the image displayed on the display surface of the display means and characterized in that three-dimensionally image is displayed by projecting light onto the transmitting plate.

According to a second aspect of the present invention, there is provided a greeting card system comprising a plurality of transparent plates and a plurality of transparent plates provided in a polygonal cone shape.

A greeting card system according to a third aspect of the present invention is characterized in that a plurality of transparent plates are provided and a plurality of transparent plates are provided in parallel to each other.

According to a fourth aspect of the present invention, there is provided a greeting card system capable of folding a base plate in a substantially flat plate shape capable of being stored in an envelope, wherein at least a part of the upper part is opened in a state where the base plate is opened and an image is displayed on the base plate A display stand for supporting the display rises from the base plate. While being disposed inclined with respect to the plane, the three-dimensional display has a surface providing a light-transmitting plate forming an inclined surface, wherein a projection is erected under the transparent plate extending from the base plate, and a storage is also provided for storing an image to be displayed on the display surface, wherein the display means is provided on a display support, which projects from the base plate once the base plate is opened. An image is displayed on the display surface, and the result is that an image is stereoscopically displayed through the transparent plate.

In a further embodiment, the greeting card system has a transparent plate consisting of a plurality of plates, the plurality of light-transmitting plate characterized in that they provide a polygonal pyramid shape.

In a further embodiment, the greeting card system has a plurality of transparent plates provided in parallel to each other.

According to a seventh aspect of the present invention, there is provided a greeting card system capable of folding a base plate in a substantially flat plate shape that can be accommodated in an envelope, at least a part of the upper part being opened in a state where the base plate is opened and displaying an image on the base plate. A display support exists for erecting the display and positioning it on the display support. While being disposed inclined to the plane, a greeting card surface of the inclined surface is in the stereoscopic display unit has a light-transmitting plate, and the display surface is connected to the information communication network. Data storage for storing an image to be displayed and a storage location specifying information indicating a storage location on the information communication network of the storage means. The display support which stands on the base plate is moved into an open state when the base plate is opened. And, based on information indicated in the storage location and sent to the display, provides an image displayed on the display surface of the display unit, three-dimensionally displayed via the transparent plate.

The greeting card system according to the present invention may be characterized in that a plurality of transparent plates are provided and the plurality of transparent plates are provided in a polygonal cone shape.

A greeting card system according to a ninth aspect of the present invention is characterized in that a plurality of transparent plates are provided, and the plurality of transparent plates are provided in parallel to each other.

According to the invention of the present application, a greeting card which is capable of folding a base plate in a substantially flat plate shape is disclosed that can be stored in an envelope and, upon opening, provide a stereoscopic display image. It also has a storage for storing images to be displayed on the display surface of the display, a display support, which stands on the base plate in a state where the base plate is opened and may project an image on the transparent plate as a result of the image being displayed on the display surface of the display. It is possible to display in three dimensions, so that a greeting card capable of three-dimensionally displaying a video can be stored in an envelope and sent by mail etc. by simple means.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a system diagram showing an embodiment of a configuration of a greeting card system according to the present invention.

FIG. 2 shows an elevation view of a first embodiment of a greeting card used in the greeting card system.

FIG. 3 shows a perspective view of a first embodiment of a greeting card used in the greeting card system.

FIG. 4 shows a perspective view of a first embodiment of a greeting card used in the greeting card system.

FIG. 5 shows an elevation view of a first embodiment of a greeting card used in the greeting card system.

FIG. 6 shows an elevation view of a first embodiment of a greeting card used in the greeting card system.

FIG. 7 shows a perspective view of a second embodiment of a greeting card used in the greeting card system.

FIG. 8 shows a detail view of a third embodiment of a greeting card used in the greeting card system.

FIG. 9 shows a detail view of a fourth embodiment of a greeting card used in the greeting card system.

FIG. 10 is a detail view showing a part of a greeting card used in the greeting card system.

FIG. 11 is a view showing a part of a greeting card used in the greeting card system.

### DETAILED DESCRIPTION OF PREFERRED EMBODIMENTS

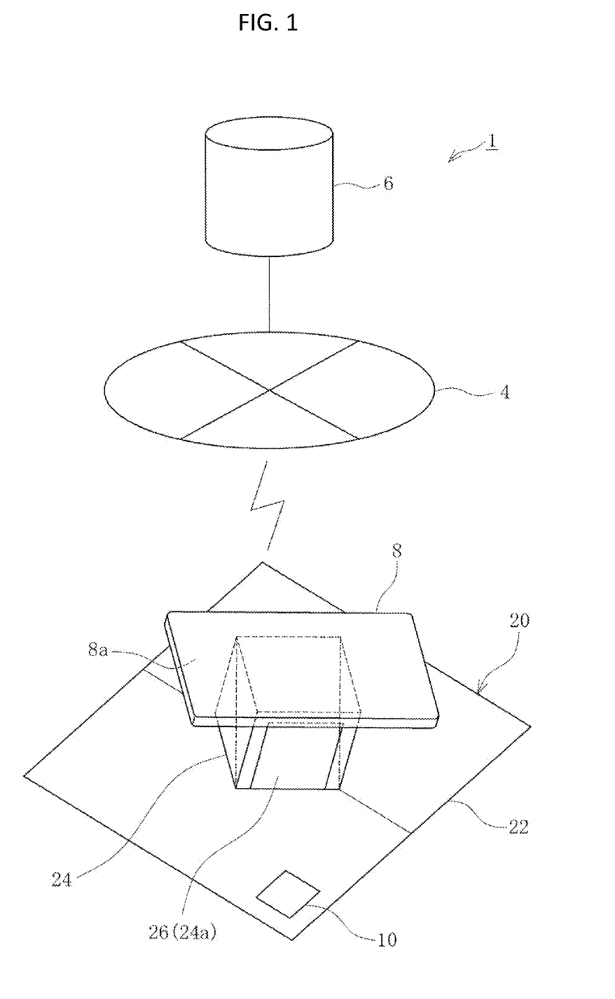

Preferred embodiments of the present invention and their advantages may be understood by referring to FIGS. 1-11, wherein like reference numerals refer to like elements.

The greeting card system according to the present invention uses a greeting card that can be accommodated in an envelope, and the greeting card itself serves as a stereoscopic display unit, enabling the image to be stereoscopically displayed. The image to be displayed in three dimensions mainly indicates the contents as a greeting card and it is the content to tell the person who received the stereoscopic video containing the feeling of the sender's celebration such as a birthday celebration or a birth celebration is there. In addition, the image to be stereoscopically displayed may be newly created for the person to receive by the sender, or may be one prepared beforehand, or may be one provided beforehand May be used. It should be noted that the invention is not limited by the content of the greeting card and the image displayed stereoscopically.

First, the outline of the greeting card system of the present invention will be described with reference to FIG. 1. FIG. 1 is a configuration diagram showing an example configuration of a greeting card system according to the present invention. The greeting card system 1 is composed of a greeting card 20, a server 6, and the like. The details of the greeting card 20 shown in FIG. 1 will be described in detail in the description of the first embodiment, but the greeting card 20 is a stereoscopic display means for stereoscopically displaying images, and in the folded state, the general Like a greeting card.

In the greeting card 20, the base plate 22 can be folded in a substantially flat plate shape capable of being stored in an envelope, and at least a part of the upper side is opened in a state in which the base plate 22 is opened, and in order to display an image on the base plate 22 of the display, the display support 24 rises up from the base plate 22 when the base plate 22 is opened. A translucent plate 26 that is disposed to be inclined with respect to the display surface and in which the surface of the inclined surface is provided, mounted within the display support 24.

Here, the display is, for example, a display 8 such as a smartphone or a tablet terminal, and its display surface is the display surface 8a which is the screen of the display 8. In the following description, as an example of display means, description will be made using a display 8 in the form of a smartphone. It should be noted that the display is not limited to the display 8, and at least the display means 8a is capable of projecting an image for stereoscopically displaying an image on a translucent plate 26 which will be described later. Although the image is originally displayed on the display surface 8a in a planar manner, it is projected on the inclined translucent plate 26 of the display support 24 of the greeting card 20, so that the image appears stereoscopically when viewer by a viewer.

The server 6 is a storage unit that stores images to be displayed on the display surface 8a of the display 8 which is a display unit, and in the example of FIG. 1, the server 6 is connectable to the display 8 via the information communication network 4. That is, the server 6 is a storage device for storing the image to be displayed on the display surface of the display, in communication with the information communication network 4. The storage device for storing the image to be displayed on the display surface 8a of the display 8 is not limited to the server 6 connectable to the display 8 via the information communication network 4 but may be a display 8 which is removable from the memory. That is, for example, memory may be enclosed and sent in the greeting card 20 and the envelope. Further, regarding the information communication network 4 connecting the display 8 and the server 6, it may be a public line network or an Internet network, may be wireless or wired, and if the storage unit and the display unit can be connected in such a manner.

Bar code 10 is shown on the base plate 22 of the greeting card 20 of FIG. 1. This barcode 10 is an example of a storage location explicitly for displaying information indicating the storage location on the information communication network 4 of the video to be displayed on the display surface 8a of the display 8. In particular, the barcode 10 indicates address information such as a URL on the information communication network 4, and when the barcode 10 is read by the display 8, the display 8 is ready to receive video from the server 6. It should be noted that the storage location determination mechanism is not limited to the barcode 10 described on the base board 22 of the greeting card 20 but may be stored in another paper enclosed in the greeting card 20. Alternatively, information indicating the storage location can be grasped directly by the display 8, such as a specific home page displaying information indicating the storage location of the URL or the like, or e-mail. It is also possible to use any other similar medium, and it is not limited by the form of the storage location explicit means.

As a method of using the greeting card system 1 having such a configuration, the sender first prepares the image to be three-dimensionally displayed by storing it in the server 6 as the storage means. Next, the greeting card 20 in which the information indicating the storage location of the video is described is sent to the person who wishes to send in the envelope in a folded state. Incidentally, the sender himself may send the greeting card 20 him or herself, or may request the business operator including the description of the barcode 10.

A person who receives the greeting card 20 may display the image on the display surface 8a of the display 8 as display means. Specifically, the display 8 reads the barcode 10, which is the means for specifying the storage location of the video, receives the video from the server 6 from the storage, obtains the video from the memory means, and displays Thereby making it possible to display an image on the surface 8a.

Also, the received person opens the folded greeting card 20 as shown in FIG. 1 and places the display 8 on the display means placing section 24 with the display surface 8 a facing downward. In this state, images are displayed on the display surface 8 of the display 8. Then, the image displayed on the display surface 8a is projected on the light-transmitting portion 26, and the image projected on the light transmitting portion 26 appears three-dimensional to a viewer.

According to the greeting card system 1 having such a configuration, the greeting card 20 capable of stereoscopically displaying images can be housed in an envelope and easily sent by mail or the like, and the received person may enjoy the stereoscopic image easily.

### EXAMPLE 1

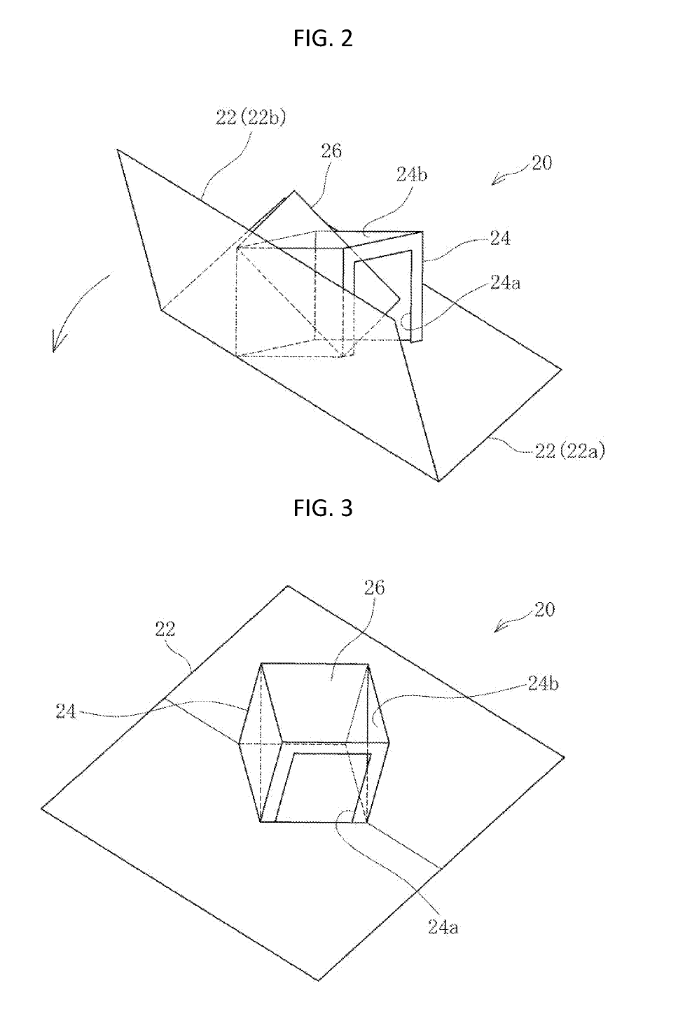

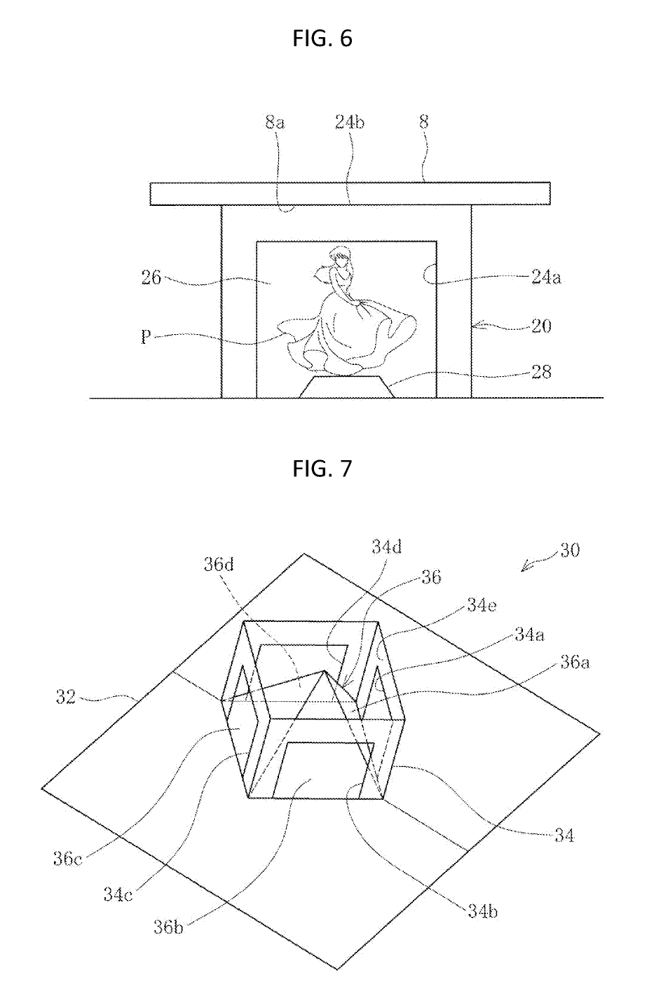

In this embodiment, an example of a form of a greeting card is shown. FIG. 2 to 5 are explanatory diagrams showing a first embodiment of a greeting card used in the greeting card system. FIG. 6 is a flow chart showing a procedure of a greeting card used in the greeting card system is an explanatory view showing a modified example of the embodiment of FIG. 1.

The greeting card 20 of the first embodiment comprises a base plate 22, a display support 24, a translucent plate 26 and the like. Like the general greeting card, the base plate 22 and the display means placing section 24 are generally made of paper, but it is not limited to paper, but it may be made of thin resin or wooden It may be like a veneer. The base plate 22 can be housed in an envelope including the display support 24 and the light transmitting plate 26 in a folded state with a shape and size capable of being folded in two so as to be foldable in an envelope. That is, in a state in which the base plate 22 is folded in two, the display support 24 and the light transmitting plate 26 are also folded in a substantially flat surface.

The display support 24 has at least a part of its upper part opened (image entrance 24b) in a state in which the base plate 22 is opened, and a display 8 so that it can stand thereon. Further, with the base plate 22 opened, the display support 24, the transparent plate 26 is inclined with respect to the display surface 8a of the display 8 placed on the display support 24, and the surface of the inclined surface is visually provided Has been done. The transparent plate 26 has a property of being translucent and capable of projecting an image on the surface, and a resin plate or the like is conceivable. The translucent plate 26 is provided inside the display support 24 and is provided with a visual port 24a in the display support 24 as a portion for seeing the translucent plate 26.

The following method of using the greeting card 20 having such a structure will be described. First, with the base plate 22 of the greeting card 20 closed and the greeting card 20 flattened, it is taken out from the envelope and, as shown in FIG. 2, for example, with the right side 22a of the base plate 22 being leveled, Open the left side 22b. Then, the display support 24 folded between the right surface 22a and the left surface 22b of the base plate 22 gradually rises.

Then, with the base plate 22 fully opened, as shown in FIG. 3, the display support 24 completely rises. In this state, the upper part of the display support 24 is opened to form the image entrance 24b. A transparent plate 26 is positioned obliquely from one of the image entrance ports 24b of the display support 24. A side face 25 of the display support 24 and on which the surface of the translucent plate 26 can be seen is an opening and it becomes a viewing port 24a.

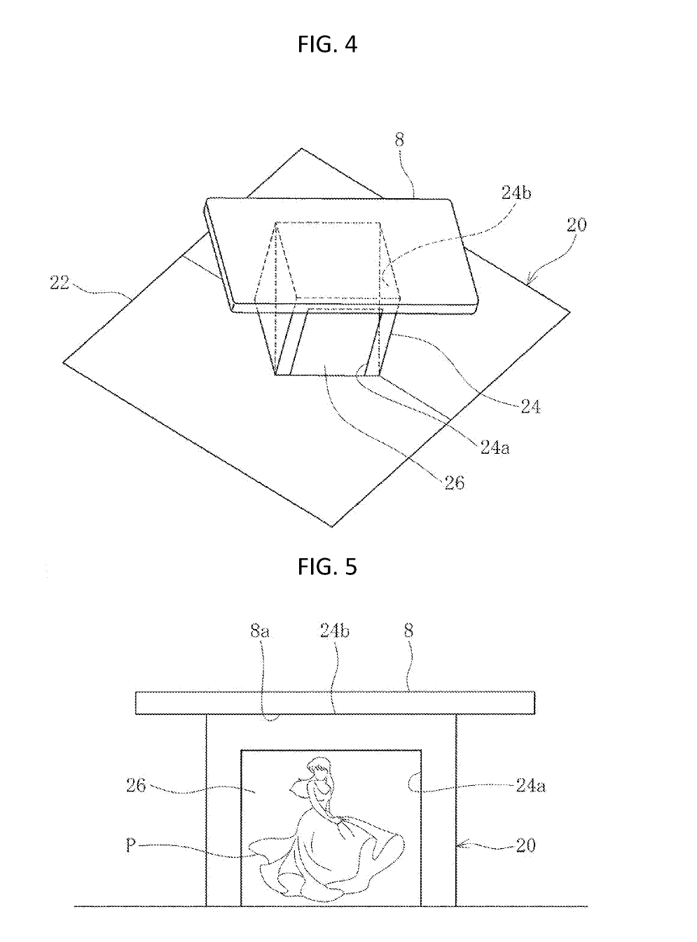

Next, as shown in FIG. 4, the display 8 is capable of displaying an image on the display surface 8a which is placed on the display means such that the display surface 8a faces downward, that is, the display surface 8a faces the light transmitting plate 26 and is connected to the display support 24. Then, when the image is displayed on the display surface 8a of the display 8, the image is projected on the transparent plate 26, and as shown in FIG. 5, when the user looks into the visual port 24a, the three-dimensional image (for example, the dancer P) as shown in FIG. 6. Then, as the image moves, for example, the appearance in which the dancer P dances is three-dimensionally displayed. By providing the protrusions 28 extending upwardly below the transparent plate 26 in a state where the base plate 22 is opened, it is possible to dispose a device such as a stage device under the transparent plate 26 In this state, if the image is projected on the transparent plate 26, and, as shown in FIG. 6, for example, the dancer P appears to be dancing on the table.

### EXAMPLE 2

In this embodiment, an example of a form of a greeting card is shown. FIG. 7 is an explanatory diagram showing a second embodiment of a three-dimensional visual greeting card used in the greeting card system.

The greeting card 30 of the second embodiment includes a base plate 32, a display support 34, a light transmitting plate 36 (36a to 36d), and the like. Like the general greeting card described above, the base plate 32 and the display support 34 are generally made of paper, but it is not limited to paper, and it is possible to use, for example, thin resin or wooden, like a veneer. The base plate 32 can be housed in an envelope including the display support 34 and the light transmitting plate 36 (36a to 36d) in a folded state with a shape and size which can be folded in two so as to be foldable in an envelope. That is, in a state in which the base plate 32 is folded in two, the display support 34 and the light transmitting plate 36 (36a to 36d) are also folded in a substantially flat surface. This permits the greeting card to be folded into, and given as, a letter.

The display support 34 has at least a part of its upper portion opened (the image entrance port 34e) in a state in which the base plate 32 is open and a display 8 so that it can stand thereon. Further, with the base plate 32 opened, the transparent plate 36 is inclined with respect to the display surface 8a of the display 8 placed on the display support 34, inside the display support 34 and a surface of the inclined translucent plate 36 is visibly provided. However, unlike the translucent plate 26 of the first embodiment, the translucent plate 36 of the second embodiment is composed of a plurality of adjacent translucent plates 36a to 36d and is provided in a quadrangular pyramidal shape. The transparent plates 36 (36a to 36d) are light-transmissive and have a property of projecting an image on the surface, and a resin plate or the like is conceivable. Visual observation ports 34a to 34d are provided on the side face of the display support 34 so that each of the light-transmissive plates 36a to 36d can be seen.

The method of using the greeting card 30 is the same as that of the greeting card 20 of the first embodiment, but in particular, the content to be projected on each of the light transmitting plates 36a to 36d of the video displayed on the display surface 8a of the display 8 Is drawn in each of the left and right front and rear views of the dancer P, for example, the dancer P is displayed three-dimensionally as the transparent plate 36 as a whole, but when the user looks into each of the visual observation ports 34a to 34b, the dancer P It is possible to stereoscopically visually recognize the left and right front and rear of the vehicle. In the example of the second embodiment shown in FIG. 7, the light transmitting plate 36 has been explained as a square pyramid shape, but it is not limited by the number of stages and the number of faces, and it may be a polygonal pyramid shape.

### EXAMPLE 3

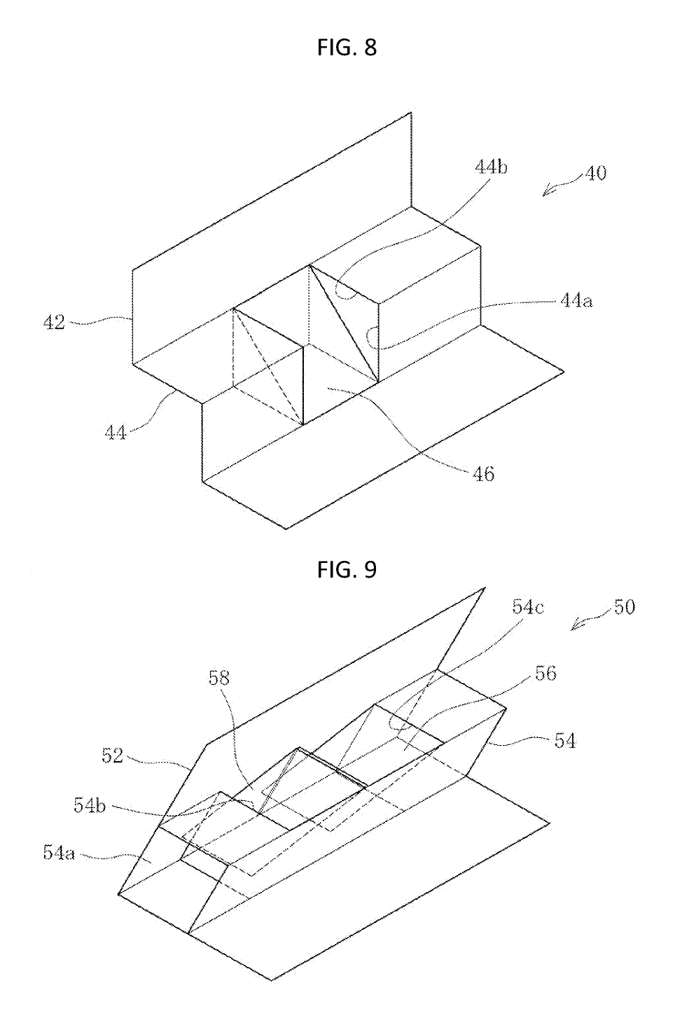

In this embodiment, an example of a form of a greeting card is shown. FIG. 8 is an explanatory diagram showing a third embodiment of the greeting card used in the greeting card system.

The greeting card 40 of the third embodiment comprises a base plate 42, a display support 44, a light transmitting plate 46 and the like. Like the general greeting card, the base plate 42 and the display means placing section 44 are generally made of paper, but it is not limited to paper, but it may be made of thin resin or wooden, like a veneer. The base plate 42 is shaped and sized so that it can be folded into two in such a manner that it can be folded in an envelope and can be stored in an envelope including the display support 44 and the transparent plate 46 in a folded state. That is, in a state in which the base plate 42 is folded in two, the display support 44 and the light transmitting plate 46 are also folded in a substantially flat surface, such that the entire construction may be placed within an envelope and given as a letter.

The display support 44 rises generally perpendicularly with respect to the base plate 42 in a form that when the base plate 42 is opened in an L-shape, at least part of the upper portion is opened (the picture entrance port 44b), and the base plate 42 and the display 8, which is a display means for displaying an image thereon, is mounted so as to be able to be positioned thereon. In a form where the base plate 42 is opened in an L-shape, the light-transmitting plate 46 is disposed inside the display support 44 on the display surface 8a of the display 8 placed on the display support 44 and the inclined surface of the light-transmitting plate is visibly provided. The translucent plate 46 is provided inside the display support 44 and the translucent plate 46 may be seen within the display support 44 through the visual port 44a.

The method of using the greeting card 40 is the same as that of the greeting card 20 of the first embodiment, wherein an image is shown on the display surface 8a, which is positioned on the display support 44 so as to face the plate 46 side. When an image is displayed on the display surface 8a, the image is projected on the transparent plate 46, and when the user looks into the visual port 44a, the image (for example, the dancer P) is three-dimensionally displayed due to the transparent nature of the plate 46. And, as the image moves, for example, the appearance in which the dancer P dances is three-dimensionally displayed.

### EXAMPLE 4

In this embodiment, an example of a form of a greeting card is shown. FIGS. 9 to 11 are explanatory diagrams showing a fourth embodiment of the greeting card used in the greeting card system.

The greeting card 50 of the fourth embodiment is composed of a base plate 52, a display means mounting portion 54, translucent plates 56, 58 and the like. Like the general greeting card, the base plate 52 and the display means placing section 54 are generally made of paper, but it is not limited to paper, but it may be made of thin resin or wooden It may be like a veneer. The base plate 52 can be housed in an envelope including the display support 54 and the light transmitting plates 56, 58 in a folded state with a shape and size capable of being folded into two so as to be foldable into an envelope. That is, in a state in which the base plate 52 is folded in two, the display support 54 and the light transmitting plates 56, 58 are also folded in a substantially flat surface.

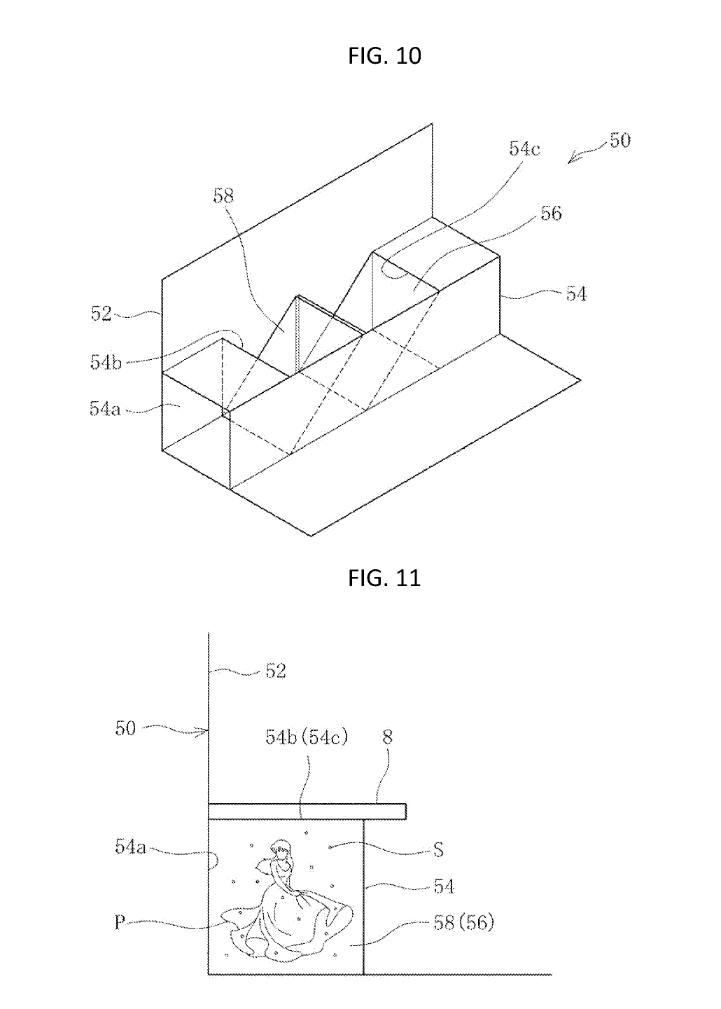

As shown in FIGS. 9 and 10, the display support 54 rises generally perpendicularly with respect to the base plate 52 in a state that the base plate 52 is opened in an L-shape, and at least two apertures are opened (image entrance ports 54b, 54c), and a display 8 for displaying an image on a base plate 52. Further, with the base plate 52 opened in an L-shape, the light transmitting plate 56 and the light transmitting plate 58 are mounted on the inside of the display support 54 on the display 8, and the surface of the inclined surface of the light transmitting plates 56, 58 is visibly provided from a visual port 54a, which is an opening on the side of the display support 54. As shown in FIG. 10, the light transmitting plate 56 and the light transmitting plate 58 are provided in parallel to each other. The number of the transparent plates 56 and 58 and the number of the image incident ports 54b and 54c may vary and may be increased or decreased in number according to function and preference.

The method of using the greeting card 50 is the same as that of the greeting card 20 of the first embodiment, and the display 8 capable of displaying the image on the display surface 8a is moved downward on the display surface 8a, that is, the display surface 8a is translucent and placed on the display support 54 so as to be on the side of the plates 56 and 58. When an image is displayed on the display surface 8a of the display 8, the image is projected on the transparent plates 56 and 58, and when the user looks into the visual port 54 a, the image (for example, the dancer P) is stereoscopically displayed. Then, as the image moves, for example, the appearance in which the dancer P dances is three-dimensionally displayed.

The content to be projected on each of the light transmitting plates 56 and 58 of the image displayed on the display surface 8a is set such that, for example, the light transmitting plate 56 is in the shape of the dancing element P and the light transmitting plate 58 receives the images S in a scattering image, representing snow, as shown in FIG. 11. When a viewer is looking into the viewing port 54a, accordingly it becomes possible for the dancer P to three-dimensionally view the figure dancing while the snow is scattering. In this way, by changing the light transmitted to plate 56 and by changing the image projected on 58, various scenes can be displayed.

### INDUSTRIAL APPLICABILITY

As described above, according to the present invention, a greeting card capable of stereoscopically displaying images can be housed in an envelope and can be easily sent by mail or the like, and the receiving person can easily view the card and benefit therefrom without the need for a computer.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A system for displaying a three-dimensional image in a greeting card, comprising:
a base plate having a first section and a second section connected therebetween by a first fold lying coextensive with a first line segment of a first line;
a display support having a first surface joined to a second surface and connected therebetween by a second fold, said second fold lying coextensive with a second line segment of a second line segment, said second line being substantially parallel to said first line;
one or more transparent plates hingedly connected to said first surface along a line segment connecting said first section to said second surface, said first surface of said display support defining at least one transparent window adjacent each said one or more transparent plates.

2. A system for displaying a three-dimensional image in a greeting card, comprising:
a base plate having a first section and a second section connected therebetween by a first fold lying coextensive with a first line segment of a first line; and
a transparent plate hingedly connected to the second section along a line segment of a second line.

3. A system for displaying a three-dimensional image in a greeting card, comprising;
a base plate having a first section and a second section connected therebetween by a first fold lying coextensive with a first line segment of a first line; and
support means, for a display, hingedly attached to the first section; and
a transparent plate connected to said support means, said support means defining a first transparent window and second transparent window, adjacent said transparent plate, lying in a plane perpendicular thereto.

4. A system for displaying a three-dimensional image in a greeting card, comprising:
a base plate having a first section and a second section connected therebetween by a first fold lying coextensive with a first line segment of a first line; and
a first transparent triangularly shaped plate connected to the first section along one triangularly-shaped side
a second transparent triangularly shaped plate connected to the second section along one triangularly-shaped side;
a third transparent triangularly shaped plate connected to the first transparent triangularly shaped plate along a second triangularly shaped side of said first transparent triangularly shaped plate; and
a fourth transparent triangularly shaped plate connected to the second transparent triangularly shaped plate along a second triangularly shaped side of said second transparent triangularly shaped plate.
